(19) United States
(12) Patent Application Publication
(10) Pub. No.: US 2008/0167895 A1
(43) Pub. Date: Jul. 10, 2008

(54) Accounting method of the remote authentication dial in user service client

(75) Inventor: R. Rahul, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: HUAWEI TECHNOLOGIES CO., LTD.

(21) Appl. No.: 12/010,151

(22) Filed: Jan. 22, 2008

Related U.S. Application Data
(63) Continuation of application No. PCT/CN2006/001818, filed on Jul. 24, 2006.

(30) Foreign Application Priority Data
Jul. 22, 2005 (CN) 200510085335.9

(51) Int. Cl. G06Q 30/00

(52) U.S. Cl. 705/1

(57) ABSTRACT

The present invention discloses a method for performing accounting of a user by a Remote Authentication Dial-In User Service client (RADIUS), the method comprising, after the user requesting for a session in order to access a network has been authenticated successfully, performing, by the RADIUS client, accounting of the user in accordance with a preset accounting policy of the RADIUS client during the session; carrying, by the RADIUS client, an amount of money consumed by the user during the present session in a Account-of-Session-Cost attribute added in the RADIUS client protocol, and sending the Account-of-Session-Cost attribute, by the RADIUS client, to a RADIUS server after the session has been finished; and updating, by the RADIUS server, information of the user in accordance with the received amount of money consumed by the user during the present session.

### CROSS-REFERENCES TO RELATED APPLICATIONS

The present application is a continuation of PCT Application No. PCT/CN2006/001818, filed on Jul. 24, 2006, which claims a priority to Chinese Patent Application No. 200510085335.9, filed on Jul. 22, 2005. All of these applications are incorporated herein by reference for all purposes.

### FIELD OF THE INVENTION

The present invention relates to a user management method in a Remote Authentication Dial-In User Service (RADIUS) environment, and in particular to an accounting method of an RADIUS Client.

### BACKGROUND OF THE INVENTION

The RADIUS is a protocol for transmitting information concerning authentication, authorization and configuration between a Network Access Server (NAS) and an RADIUS server for centralized storage of authentication information. The RADIUS operates in a client/server approach to implement identity authentication, authorization and accounting of a remote telephone dial-in user. Particularly, the RADIUS server is adapted for centralized storage of user authentication information, such as a user name and a password used by the user when making access to the Internet. The RADIUS server authenticates the user in accordance with the authentication information stored therein and returns the configuration information of the user after successful authentication. The RADIUS client is typically an NAS implemented in a dial-in way and primarily adapted to transport user information to the server.

In a typical network at present, the RADIUS server and the RADIUS client belong to the same Service Provider (SP)/network operator, and respective RADIUS clients connected to the same RADIUS server apply the same accounting policy. Therefore for convenient accounting, information required for the accounting can be placed uniformly at the RADIUS server, and the RADIUS server accomplishes accounting of respective access users.

Topologies of networks are changing constantly along with continuous development of the networks. Currently, the service provider and the network operator have been separated from the same entity to become two independent entities. FIG. 1 illustrates such a network topology in which an RADIUS server, such as a service provider, does not have a function of controlling exchange and transmission and instead is adapted to store user information and accomplish user authentication, authorization and accounting. An RADIUS client, such as a network operator, is adapted to accomplish the exchange and transmission function and to accomplish the user authentication, authorization and accounting by interacting with the service provider through the RADIUS protocol. Here, the network operator can be a fixed network operator, a wireless network operator, etc., which can provide users with an Internet access service, but the network operators may apply different accounting policies. Taking a basic Internet access as an example, costs of an access made by a user to the network may involve two parts. One is a connection cost once-accounted when the user gains an access to the Internet, and the other is an operation cost accounted in accordance with a period of time for the access made by the user to the network. Different network operators may apply different accounting policies for the connection cost and the operation cost. For instance: Network Operator 1, the connection cost is 5 RMB Yuan per time and the operation cost is 0.05 RMB Yuan per minute for a network operator 1; Network Operator 2, the connection cost is 0 RMB Yuan per time and the operation cost is 0.01 RMB Yuan pre minute. The network operators may also change their own accounting policies constantly as needed for competition.

Because the different network operators apply different accounting policies and the accounting function is accomplished by the service provider acting as the RADIUS server, it is necessary for the network operators to publish details of their own accounting policies to the service provider, which may be very adverse to privacy of the accounting policies of the network operators. Further, since the service provider performs different accounting method on a user according to different network operators through which the user has gained the access to the network, this may result directly in an increased complexity of the accounting function of the service provider. Additionally as needed for competition, the network operators may adjust their accounting policies constantly, and the accounting polices of the network operators stored in the service provider also need to be updated accordingly while the accounting policies are adjusted, which may not only increase the complexity of accounting, but also cause a time delay of applying the accounting policies. The above problems will be apparent especially in the RADIUS environment where a plurality of network operators and a plurality of service providers are present.

### SUMMARY OF THE INVENTION

In view of the above, the invention provides an accounting method for an RADIUS client so that the complexity of an RADIUS server can be reduced and the privacy of accounting policies of network operators can be guaranteed.

The invention provides a method for performing accounting of a user by a Remote Authentication Dial-In User Service client, wherein the method comprises, after the user requesting for the session has been authenticated successfully:

performing, by the Remote Authentication Dial-In User Service client, accounting of the user in accordance with a preset accounting policy of the Remote Authentication Dial-In User Service client during the session;

carrying, by the Remote Authentication Dial-In User Service client, an amount of money consumed by the user during the present session in a Account-of-Session-Cost attribute added in the Remote Authentication Dial-In User Service client protocol, and sending the Account-of-Session-Cost attribute, by the Remote Authentication Dial-In User Service client, to a Remote Authentication Dial-In User Service server after the session has been finished; and

updating, by the Remote Authentication Dial-In User Service server, information of the user in accordance with the received amount of money consumed by the user during the present session.

As can be seen from the above method, the method of the invention adds the Account-of-Session-Cost attribute in the RADIUS protocol so that the RADIUS client can send an amount of money consumed by a user during a session to the RADIUS server to update a balance of the user, thereby enabling updating of the user balance and further an accounting operation of the RADIUS client. Thus, the method of the invention can not only reduce the complexity of the accounting function of the RADIUS server, but also guarantee privacy of policies of the network operators.

### BRIEF DESCRIPTION OF THE DRAWINGS

FIG. 1 illustrates a schematic diagram of a network topology in which a network operator and a service provider are separated into two entities;

FIG. 2 is a flow chart of performing accounting of a user by an RADIUS client according to an embodiment of the invention; and

FIG. 3 is a flow chart of performing accounting of a prepay user by an RADIUS client according to another embodiment of the invention.

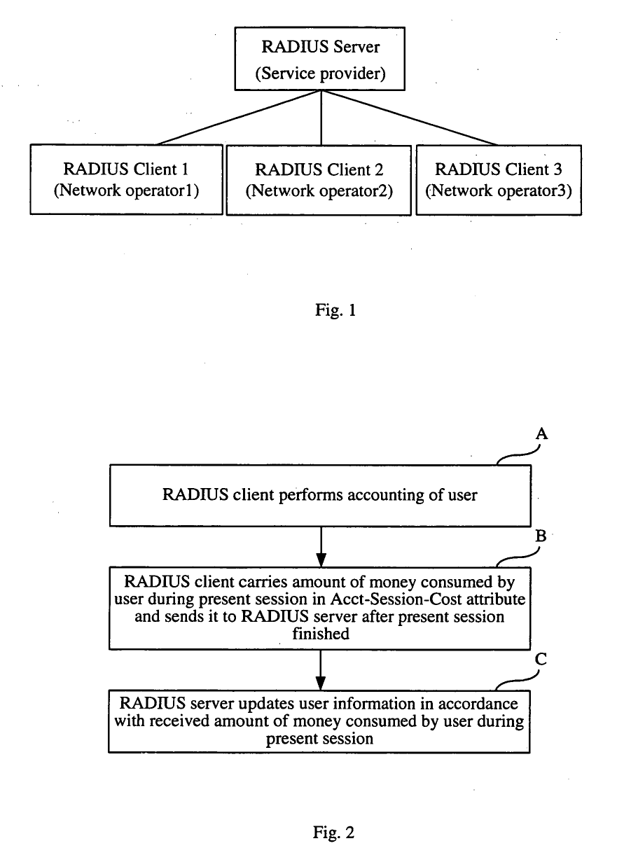

### DETAILED DESCRIPTION OF THE INVENTION

In order to address the problems present in the related art and enable network operators such as an RADIUS client to perform accounting, the invention extends the existing RADIUS protocol by adding an account-of-session-cost (Acct-Session-Cost) attribute carrying cost consumed during a session. After the session has been finished, the RADIUS client calculates the amount of money consumed by a user during the present session and sends the amount of money consumed by the user at this time to the RADIUS server through the added Acct-Session-Cost attribute, so as to update the user corresponding record stored in the RADIUS server.

For a prepay user, it is necessary to add a Session-Balance attribute carrying a balance of a prepay card used by the prepay user in attributes specified in the RADIUS protocol. The RADIUS server such as a service provider can send the balance of the prepay card used by the prepay user to the RADIUS client through the Session-Balance attribute so that the RADIUS client accomplishes accounting of the user based on the balance of the prepay card.

The above mentioned Session-Balance attribute and the Acct-Session-Cost attribute each includes three parts, i.e. a Type part, a Length part and a Value part, just as the other attributes specified in the RADIUS protocol. Specific definitions of the Session-Balance attribute and the Acct-Session-Cost attribute are as illustrated in Table 1. More specifically, the part of Type is represented with 1 byte and indicates whether the attribute is the Session-Balance attribute or the Acct-Session-Cost attribute, and the value of the part of Type is not limited in the method of the invention and can be defined as any reserved value specified in the RADIUS protocol. The part of Length is also represented with 1 byte and indicates a length of the Session-Balance attribute or a length of the Acct-Session-Cost attribute. The part of Value carries contents of the respective attributes. For the Session-Balance attribute, the part of Value indicates a balance of the prepay card used by the prepay user and is represented with 4 bytes, i.e., a 32-bit unsigned integer, and for the Acct-Session-Cost attribute, the part of Value indicates an amount of money consumed by the user during a session and is represented with 4 bytes, i.e., a 32-bit unsigned integer. As can be seen from this, the Session-Balance attribute and the Acct-Session-Cost attribute each has a total length of 6 bytes. The Session-Balance attribute can be carried in an Access-Accept message or an Access-Challenge message, and the Acct-Session-Cost attribute can be carried in an Accounting-Request message. The Session-Balance attribute and the Acct-Session-Cost attribute may not occur or may occur once in the above messages. That is, these two attributes are optional attributes in the messages.

TABLE 1

| | | | | | The number of |
|---|---|---|---|---|---|
| | | | | | times of |
| Attribute name | Type | Length | Value | Carrying message | occurrence |
| Session Balance | TBD* | 6 | Maximum | Access-Accept, | 0-1 |
| | | | cost | Access-Challenge | |
| | | | allowed | | |
| | | | to be used | | |
| | | | by user in | | |
| | | | present | | |
| | | | session | | |
| Acct-Session-Cost | TBD* | 6 | Amount | Accounting-request | 0-1 |
| | | | of money | | |
| | | | consumed | | |
| | | | by user in | | |
| | | | present | | |
| | | | session | | |

Noted that TBD* indicates that a value for the Type of the attribute can be any reserved value specified in the RADIUS protocol and shall be determined in a practical application.

As can be seen from this, the RADIUS server can send information on a balance of the prepay card used by the prepay user to the corresponding RADIUS client through the Session-Balance attribute, and the RADIUS client can send the amount of money consumed by the user during a session to the RADIUS server through the Acct-Session-Cost attribute.

FIG. 2 is a flow chart of method for performing accounting of an RADIUS client according to an embodiment of the invention. As illustrated in FIG. 2, after a user has been authenticated successfully, the flow primarily includes the following processes.

A. During a session, the RADIUS client performs accounting of the user.

The accounting in this step involves that the RADIUS client calculates the amount of money consumed by the user during the present session in accordance with its own preset accounting policy.

In an embodiment of the invention, the RADIUS client can perform real time accounting in accordance with a period of time for an access made by the user to the network. For instance, if an accounting policy of a network operator is 0 RMB Yuan per time for the connection cost and 0.01 RMB Yuan per minute for the operation cost, and a cumulative period of time for the access made by the user to the network is 100 minutes, then an amount of money consumed by the user during the present session is 0+0.01×100=1 (RMB Yuan).

B. After the session has been finished, the RADIUS client carries the amount of money consumed by the user during the present session in the Acct-Session-Cost attribute and sends it to the RADIUS server.

In this step, the Acct-Session-Cost attribute can be carried in the Accounting-Request message sent from the RADIUS client to the RADIUS server.

Since the Acct-Session-Cost attribute is sent after the session between the user and the Internet has been finished, a value of the Acct-Session-Type attribute carried in the Accounting-Request message carrying the Acct-Session-Cost attribute shall be “STOP”.

C. The RADIUS server updates its own stored information of the user in accordance with the received amount of money consumed by the user during the present session.

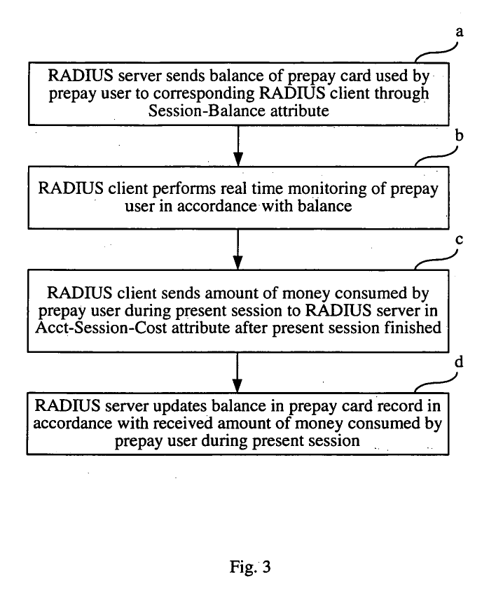

FIG. 3 illustrates a flow chart of a method for performing accounting of a prepay user by the RADIUS client according to another preferred embodiment of the invention. As illustrated in FIG. 3, after the prepay user has been authenticated successfully, this method primarily includes the following processes.

a. The RADIUS server sends a balance of a prepay card used by the prepay user to the corresponding RADIUS client through the Session-Balance attribute prior to a session.

In this step, the Session-Balance attribute can be carried in the Access-Accept message or the Access-Challenge message sent from the RADIUS server to the RADIUS client.

b. The RADIUS client performs real time accounting of the prepay user in accordance with the balance during the session.

More specifically, when the RADIUS client performs real time accounting of the prepay user, the RADIUS client calculates the amount of money consumed by the prepay user during the present session in accordance with its own accounting policy. In an embodiment of the invention, the RADIUS client can perform the real time accounting in accordance with a period of time for the access made by the prepay user to the network. For instance, when an accounting policy of a network operator is 0 RMB Yuan pre time for the connection cost and 0.01 RMB Yuan per minute for the operation cost, each time the period of time for the access made by the prepay user to the network is increased by 1 minute, the network operator adds 0.01 RMB Yuan to the amount of money consumed by the prepay user during the present session and compares the increased amount of consumed money with the balance information received from the RADIUS server. Once the amount of money consumed by the prepay user reaches the balance, the RADIUS client disconnects the prepay user from the Internet, stops the present session and prompts the user to note the insufficient balance; otherwise, the RADIUS client proceeds with accounting in accordance with its own accounting policy until the prepay user quits the Internet, and stops the present session.

c. The RADIUS client sends the amount of money consumed by the prepay user during the present session to the RADIUS server through the Acct-Session-Cost attribute after the session has been finished.

In this step, the Acct-Session-Cost attribute can be carried in the Accounting-Request message sent from the RADIUS client to the RADIUS server, and as described previously, a value of the Acct-Session-Type attribute in the message shall be “STOP”.

d. The RADIUS server updates the balance information in a record of the prepay card in accordance with the received amount of money consumed by the prepay user during the present session.

In this step, the updating includes the process that the RADIUS server subtracts the received amount of money consumed by the prepay user during the present session from its own recorded balance of the prepay card, and the process that the RADIUS server replaces the originally stored balance with a value of the difference obtained by the subtraction as a new balance.

The method according to the embodiments will be described in details below by way of specific examples.

After a prepay user has been authenticated successfully, a service provider acting as the RADIUS server sends the balance of the prepay card used by the prepay user, which balance is recorded in the user record of the RADIUS server, e.g., 10 RMB Yuan, to a corresponding network operator acting as the RADIUS client through the Session-Balance attribute carried in the Access-Accept message or Access-Challenge message.

During a session, the network operator performs real time calculation of an amount of money consumed by the prepay user during the present session in accordance with its own accounting policy, for instance, when the accounting policy of the network operator is 0 RMB Yuan per time for the connection cost and 0.01 RMB Yuan per minute for the operation cost, the network operator calculates the amount of money consumed by the prepay user once per minute. The calculated amount of consumed money is 0+0.01×100=1 (RMB Yuan) when a period of time for the access made by the prepay user to the Internet is 100 minutes, and is 0+0.01×1000=10 (RMB Yuan) when the period of time for the access made by the prepay user to the Internet is 1000 minutes.

When the network operator detects that the amount of money consumed by the prepay user during the present session exceeds the amount of money of the prepay card used by the prepay user, i.e. 10 RMB Yuan, the network operator disconnects on its own initiative the prepay user from the Internet, stops the present session and prompts the user to note the insufficient balance of the prepay card. After that, the network operator sends the amount of money consumed by the prepay user during the present session, i.e. RMB Yuan, to a corresponding service provider through the Acct-Session-Cost attribute carried in the Accounting-Request message.

If the amount of consumed money is less then the balance of the prepay card, for example, if only 1 RMB Yuan is consumed, when the prepay user quits the Internet and stops the present session, the network operator sends the amount of money consumed by the prepay user during the present session, i.e. 1 RMB Yuan, to the corresponding service provider through the Acct-Session-Cost attribute in the Accounting-Request message.

Upon reception of the amount of money consumed by the prepay user during the present session, e.g., 10 RMB Yuan or 1 RMB Yuan, the service operator updates its own recorded balance of the prepay card used by the prepay user as 0 RMB Yuan that equals 10 minus 10, or as 9 RMB Yuan that equals 10 minus 1, in accordance with the amount of money consumed by the prepay user.

As can be seen from the above method, accomplishment of accounting of prepay users by the network operator acting as the RADIUS client can not only reduce the complexity of the service provider acting as the RADIUS server, but also guarantee the privacy of policies of the network operators.

1. A method for performing accounting of a user by a Remote Authentication Dial-In User Service client, the method comprising, after the user requesting for a session in order to access a network has been authenticated successfully:
performing, by the Remote Authentication Dial-In User Service client, accounting of the user in accordance with a preset accounting policy of the Remote Authentication Dial-In User Service client during the session;
carrying, by the Remote Authentication Dial-In User Service client, an amount of money consumed by the user during the present session in a Account-of-Session-Cost attribute added in the Remote Authentication Dial-In User Service client protocol, and sending the Account-of-Session-Cost attribute, by the Remote Authentication Dial-In User Service client, to a Remote Authentication Dial-In User Service server after the session has been finished; and
updating, by the Remote Authentication Dial-In User Service server, information of the user in accordance with the received amount of money consumed by the user during the present session.

2. The method according to claim 1, wherein the user is a prepay user.

3. The method according to claim 2, wherein the method further comprises:
adding a Session-Balance attribute in the Remote Authentication Dial-In User Service protocol;
carrying, by the Remote Authentication Dial-In User Service server, a balance of a prepay card used by the prepay user in the Session-Balance attribute, and sending the Session-Balance attribute, by the Remote Authentication Dial-In User Service server, to a corresponding Remote Authentication Dial-In User Service client prior to the session.

4. The method according to claim 3, wherein the method further comprises:
comparing, by the Remote Authentication Dial-In User Service client, the amount of consumed money calculated in accordance with the preset accounting policy of the Remote Authentication Dial-In User Service client with the balance of the prepay card received from the Remote Authentication Dial-In User Service server; when the amount of money consumed by the prepay user reaches the balance, disconnecting the prepay user from the network.

5. The method according to claim 3, wherein the Session-Balance attribute is carried in an Access-Accept message or an Access-Challenge message based on the Remote Authentication Dial-In User Service client protocol and sent from the Remote Authentication Dial-In User Service server to the Remote Authentication Dial-In User Service client.

6. The method according to claim 3, wherein the updating comprises a process of subtracting, by the Remote Authentication Dial-In User Service server, the received amount of money consumed by the prepay user during the present session from the balance of the prepay card recorded in the Remote Authentication Dial-In User Service server, and a process of replacing, by the Remote Authentication Dial-In User Service server, the originally stored balance with a value of difference obtained from the subtraction as a new balance.

7. The method according to claim 1, wherein the Account-of-Session-Cost attribute is carried in an Accounting-Request message based on the Remote Authentication Dial-In User Service client protocol and sent from the Remote Authentication Dial-In User Service client to the Remote Authentication Dial-In User Service server.
